(19) United States
(12) Patent Application Publication
(10) Pub. No.: US 2011/0262338 A1
(43) Pub. Date: Oct. 27, 2011

(54) METHOD AND SYSTEM FOR THE PRODUCTION OF PURE SILICON

(75) Inventors: Christian Schmid, Freudenstadt (DE); Adolf Petrik, Freudenstadt (DE); Jochem Hahn, Rottenburg (DE)

(73) Assignee: SCHMID SILICON TECHNOLOGY GMBH, Freudenstadt (DE)

(21) Appl. No.: 12/935,093

(22) PCT Filed: Mar. 31, 2009
(86) PCT No.: PCT/EP2009/002336

§ 371 Date: Dec. 8, 2010

(30) Foreign Application Priority Data
Mar. 31, 2008 (DE) 102008017304.5

(51) Int. Cl. C01B 33/021; B01J 19/00

(52) U.S. Cl. 423/349; 422/187

(57) ABSTRACT

A process for producing high-purity silicon includes (1) preparing trichlorosilane by reacting silicon with hydrogen chloride in at least one hydrochlorination process; (2) preparing monosilane by disproportionation of the trichlorosilane to provide a monosilane-containing reaction mixture containing silicon tetrachloride as a by-product; (3) in parallel to (1), reacting silicon tetrachloride obtained as the by-product in (2) with silicon and hydrogen in at least one converting process to produce a trichlorosilane-containing reaction mixture; and (4) thermally decomposing the monosilane into silicon and hydrogen.

### RELATED APPLICATIONS

This is a §371 of International Application No. PCT/EP2009/002336, with an international filing date of Mar. 31, 2009, which is based on German Patent Application No. 102008017304.5 filed Mar. 31, 2008, the subject matter of which is incorporated by reference.

### TECHNICAL FIELD

This disclosure relates to a multistage process for producing high-purity silicon and also a plant in which such a process can be carried out.

### BACKGROUND

High-purity silicon is generally produced in a multistage process from metallurgical silicon which can have a relatively high proportion of impurities. To increase the efficiency of the purification and to reduce the specific energy consumption, metallurgical silicon can be converted, for example, into a trihalosilane which is subsequently thermally decomposed to give high-purity silicon. Such a procedure is known, for example, from DE 29 19 086. In other processes, for example that described in DE 33 11 650, the thermal decomposition starts out not from, for instance, a trihalosilane but instead from monosilane (SiH₄) which can be obtained, in particular, by disproportionation of chlorosilanes. The chlorosilanes required are obtained as described in DE 33 11 650 by reaction of metallurgical silicon, silicon tetrachloride and hydrogen at from 400° C. to 600° C.

All processes known hitherto have the disadvantage that the energy consumption for the overall process for converting metallurgical silicon into high-purity silicon is extraordinarily high, which has, particularly in recent years, continued to drive the price of high-purity silicon to high levels. In addition, many of the known processes have the disadvantage that they are not optimized in terms of the formation and reuse or further use of by-products. In terms of both economic and ecological considerations, known processes are in need of a great deal of improvement, especially in terms of this aspect.

It could therefore be helpful to provide an industrial solution to the production of high-purity silicon which meets even the most demanding requirements with regard to the problems mentioned.

### SUMMARY

We provide a process for producing high-purity silicon including (1) preparing trichlorosilane by reacting silicon with hydrogen chloride in at least one hydrochlorination process; (2) preparing monosilane by disproportionation of the trichlorosilane to provide a monosilane-containing reaction mixture containing silicon tetrachloride as a by-product; (3) in parallel to (1), reacting silicon tetrachloride obtained as the by-product in (2) with silicon and hydrogen in at least one converting process to produce a trichlorosilane-containing reaction mixture; and (4) thermally decomposing the monosilane into silicon and hydrogen.

We also provide a plant for producing high-purity silicon including a production unit that prepares trichlorosilane, a further unit that prepares monosilane by disproportionation of the trichlorosilane prepared in the production unit and a decomposition unit that thermally decomposes the monosilane into silicon and hydrogen, wherein:

the production unit includes at least one hydrochlorination reactor in which silicon is reacted with hydrogen chloride and produces a trichlorosilane-containing reaction mixture, at least one converting reactor in which silicon tetrachloride is reacted with silicon and hydrogen and produces a trichlorosilane-containing reaction mixture, at least one collection vessel in which the trichlorosilane-containing reaction mixtures prepared are mixed and/or stored and at least one separation apparatus downstream of the at least one collection vessel and in which the trichlorosilane-containing reaction mixture is at least partially separated into its components;

the further unit includes at least one disproportionation reactor in which trichlorosilane from the production unit is converted under catalytic conditions into silicon tetrachloride and a monosilane-containing reaction mixture and at least one separation apparatus in which chlorosilane is separated from the monosilane-containing reaction mixture; and

the decomposition unit includes at least one decomposition reactor in which monosilane from the production unit is contacted with at least one support heated to 800° C.-1450° C. (surface temperature); and

the further unit is connected to the production unit via at least one return line via which silicon tetrachloride obtained in the further unit is fed into the at least one converting reactor in the production unit.

### BRIEF DESCRIPTION OF THE DRAWING

FIG. 1 shows a flow diagram of an example of the process for producing high-purity silicon.

### DETAILED DESCRIPTION

The process for producing high-purity silicon can be divided into essentially three sections, namely a section (1) in which trichlorosilane is prepared, a section (2) in which the trichlorosilane prepared in section (1) is disproportionated and a section (3) in which the monosilane prepared in section (2) is converted by thermal decomposition into silicon and hydrogen.

High-purity silicon is, in particular, silicon which can be directly processed further in the semiconductor industry, for example for producing solar cells or microchips. The silicon used in the hydrochlorination process, on the other hand, is preferably metallurgical (crude) silicon which still has a high level of impurities.

Our process is particularly characterized in that section (1) comprises at least two processes which proceed parallel to one another and in each of which a trichlorosilane-containing reaction mixture is obtained. Section (1) firstly comprises at least one hydrochlorination process in which silicon is reacted with hydrogen chloride and secondly at least one converting process in which silicon tetrachloride is reacted with silicon and hydrogen. The converting process, too, comprises a hydrochlorination, namely a hydrochlorination of the silicon used, but in contrast to the hydrochlorination process also the conversion of silicon tetrachloride. The silicon tetrachloride used in the converting process comes at least partly from section (2). The monosilane-containing reaction mixture obtained by disproportionation of the trichlorosilane prepared in section (1) always contains a removable proportion of silicon tetrachloride as by-product.

The process is distinguished from the procedure described in DE 33 11 650 by having a hydrochlorination step using hydrogen chloride. Such a procedure is described as energy-inefficient and difficult to manage in DE 33 11 650.

The individual sections (1) to (3) are described in detail below.

In addition to the at least one hydrochlorination process mentioned and the at least one converting process, section (1) preferably further comprises at least one purification process in which the trichlorosilane-containing reaction mixture obtained in these processes is worked up, in particular freed of various by-products. The at least one purification process preferably comprises at least one dry purification stage and/or at least one wet purification stage.

In the at least one dry purification stage, the solid, coarsely particulate constituents of the reaction mixture are preferably separated in a first step. The dry purification step can for this purpose have one or more cyclones. In a second step, finely divided suspended particles are removed from the reaction mixture by filtration. Suitable cyclones and filters for this purpose are known.

The abovementioned purification steps are preferably carried out at temperatures in the range from 170° C. to 220° C., preferably from 190° C. to 200° C.

The at least one wet purification stage preferably also comprises two steps. Thus, it has been found to be particularly advantageous to carry out precooling of the reaction mixture to be purified in a first step (but without bringing about total condensation of the reaction mixture). Such precooling can be effected, for example, by a suitable gas scrubber, for example a Venturi scrubber. In a second step, impurities such as hydrogen chloride and hydrogen can then be separated off from the reaction mixture, for example by a further Venturi scrubber.

Preferably, the purified reaction mixtures from the at least one hydrochlorination process and the at least one converting process are each transferred to a collection vessel in which they are stored for some time until the mixtures are in chemical equilibrium. They can subsequently be worked up together in mixed form. Particularly preferably, the reaction mixtures from the at least one hydrochlorination process and the at least one converting process can also be mixed before transfer to at least one common collection vessel.

A mixing ratio in the range from 10% to 50% or from 1:10 to 10:1 is preferably adhered to in the mixing of the reaction mixtures from the at least one hydrochlorination process and the at least one converting process. The proportion by volume of reaction mixture from the at least one converting process is particularly preferably in the range from 50% to 95%, in particular from 75% to 95%, after mixing.

Apart from the processes addressed above, section (1) preferably comprises at least one thermal separation process in which the trichlorosilane-containing reaction mixture from the at least one hydrochlorination process and/or the at least one converting process is at least partially separated into its components. The at least one thermal separation process is preferably located downstream of the at least one purification process so that the trichlorosilane-containing reaction mixtures from the various processes do not necessarily have to be worked up separately. The at least one thermal separation process is particularly preferably carried out after the above-described storage of the purified reaction mixtures in the collection vessels.

Apart from trichlorosilane, the reaction mixtures from the at least one hydrochlorination process and/or the at least one converting process generally contain monochlorosilane, dichlorosilane and in particular tetrachlorosilane. The latter in particular can readily be separated off in the at least one thermal separation process in section (1). However, it is preferably not discarded after the separation but is instead reused in section (1), in particular by introduction into the at least one converting process.

The hydrochlorination of the metallurgical silicon is preferably carried out at a temperature in the range from 320° C. to 400° C. Within this range, temperatures of from 350° C. to 370° C. are more preferred.

The pressure in the hydrochlorination in section (1) is preferably set to a value in the range from 2 at to 12 at.

Fine silicon particles are particularly preferably used as starting material in the hydrochlorination process, preferably particles having a diameter in the range from 0.4 mm to 3.3 mm, in particular a diameter in the range from 0.5 mm to 1.6 mm.

The converting of silicon tetrachloride in section (1) is preferably carried out at a temperature in the range from 450° C. to 650° C. Within this range, a temperature of from 500° C. to 600° C. is more preferred.

The pressure in the converting in section (1) is preferably set to a value in the range of 8 at to 15 at.

Pulverulent silicon is preferably added as starting material to the silicon tetrachloride in the converting in section (1), in particular silicon particles having a diameter in the range from 0.4 mm to 2.0 mm, in particular from 0.5 to 2.0 mm.

Preferably, converting of silicon tetrachloride in section (1) is carried out under catalytic conditions. Possible catalysts are, in particular, iron- and/or copper-containing catalysts, with preference being given to using the latter. A suitable iron-containing catalyst is, in particular, metallic iron (for example in the form of iron powder) and even better metallic copper (for example in the form of copper powder or copper flakes). This can be mixed beforehand with the metallic silicon required in the converting process, which has in some cases been found to be very advantageous.

The disproportionation of trichlorosilane in section (2) generally results in not only silicon tetrachloride, but also monochlorosilane and dichlorosilane as by-products. The disproportionation of the trichlorosilane itself in section (2) of the process is preferably carried out in a heterogeneous system composed of liquid and gaseous starting materials, products and possibly further participating materials such as catalysts. Such a system is described, for example, in DE 25 07 864. The gas phase comprises predominantly chlorosilane vapors and a monosilane which is not condensable (under process conditions). This accumulates continuously together with further relatively light phases in the upper part of the system, while heavier phases such as silicon tetrachloride descend continuously. The disproportionation of the trichlorosilane in section (2) is thus preferably carried out under nonequilibrium conditions.

As described above, silicon tetrachloride formed in the disproportionation is preferably recirculated at least partly to section (1), in particular to the converting process in section (1), where it can then be reacted with silicon and hydrogen.

The disproportionation reaction is particularly preferably a catalytic reaction over a solid. Accordingly, preference is given to carrying out the disproportionation over a solid, organic catalyst. The catalyst is preferably a weakly basic, macroporous anion-exchange resin bearing amino groups, in particular tertiary amino groups or dimetalamino groups.

Disproportionation of the trichlorosilane prepared in section (1) is preferably carried out in at least one disproportionation reactor, in particular in at least one column which is/are preferably filled to an extent of at least 50%, in particular from 75 to 85%, with the above-described solid organic catalyst. It has been found to be particularly advantageous for the lower part of the at least one disproportionation reactor to be at least partly filled with a macroporous, phenylpyridine-based, strongly basic anion-exchange resin as catalyst.

For the disproportionation of the trichlorosilane to be able to proceed without problems in the at least one disproportionation reactor, it is very important that the catalyst fixed in the disproportionation reactor is used in virtually water-free form. Even small proportions of water in the catalyst can result in hydrolysis of the trichlorosilane over the catalyst, which in turn can lead to subsequent problems such as corrosion and the neutralization of basic catalyst functions by hydrolysis products such as hydrogen chloride and possibly even poisoning of the catalyst. Particular preference is therefore given to the catalyst being brought into contact with an alcohol, in particular ethanol and/or methanol, before being used in the at least one disproportionation reactor. The alcohol can subsequently be removed by evacuation and/or by inert gas. Any residue water present is in this way removed from the catalyst.

The disproportionation of the trichlorosilane is preferably carried out at a temperature in the range from 60° C. to 120° C. A temperature gradient is preferably set in the at least one disproportionation reactor, in particular in the at least one disproportionation column. Within the at least one disproportionation reactor, the temperature gradient should preferably be 10° C./m (based on the height of the reactor).

Like the at least one converting process and the at least one hydrochlorination process in section (1), the disproportionation of the trichlorosilane in section (2) is preferably also carried out at elevated pressures, in particular at a pressure in the range from 2 at to 10 at.

Apart from disproportionation, section (2) preferably further comprises at least one thermal separation process in which the monosilane-containing reaction mixture obtained in the disproportionation is at least partially separated into its components. Components obtained are monosilane and also, in particular, chlorosilanes, especially monochlorosilane, dichlorosilane, trichlorosilane and possibly also silicon tetrachloride. The latter can, like the silicon tetrachloride formed directly in the disproportionation, be at least partly recirculated to section (1), in particular to the converting process in section (1).

Consequently, preference is given to the monochlorosilane, dichlorosilane and trichlorosilane obtained in the separation of the reaction mixture in the at least one thermal separation process also being used further in a manner analogous to this procedure. These by-products are preferably fed into the disproportionation reactor in section (2) for renewed reaction.

The thermal decomposition of the monosilane in section (3) is preferably carried out in at least one decomposition reactor in which the monosilane is brought into contact with at least one support which has been heated to a surface temperature of from 800° C. to 1450° C.

The at least one support can be, for example, rods, tubes or plates of preferably high-purity silicon or another material which does not contaminate silicon.

The monosilane is preferably fed as a mixture with a carrier gas into the at least one decomposition reactor. The carrier gas is particularly preferably hydrogen, but inert gases such as nitrogen or mixtures thereof with hydrogen are in principle also possible as carrier gas. The proportion of monosilane in the mixture with the carrier gas is preferably set to a value in the range from 0.5 mol % to 15 mol %, in particular from 0.5 mol % to 10 mol %.

A process is particularly preferably characterized in that the thermal decomposition of the monosilane is carried out in at least one decomposition reactor through which a mixture of monosilane and carrier gases circulates, preferably using the hydrogen formed in the pyrolysis process as carrier gas.

The circulation of the mixture is preferably carried out under the conditions of forced convection. It has been found that under such conditions, the rate or the specific speed of the deposition of silicon on the at least one support can be significantly increased, for example, by a factor of 2, which has the direct consequence of a lowering of the energy consumption and advantageously a considerable increase in the yield of deposited silicon per unit time. In addition, it has been found that the formation of by-products such as polysilanes was also able to be significantly minimized.

A major part of the mixture which has passed through the decomposition reactor is preferably recirculated into the feed line of the decomposition reactor, in particular after the mixture has been cooled and filtered to remove any entrained fine silicon powder.

As a decomposition reactor, it is possible to use an optimized classical reactor having suitable, conventional means of heating the supports and coolants for cooling the corresponding structural components or the outer wall.

The decomposition can in principle be carried out either at atmospheric pressure or at elevated pressure, e.g. at pressures of up to 10 bar. The abovementioned forced convection of the gas mixture is achieved, in particular, by a high-pressure blower which is provided with throughput regulation and is preferably preceded directly by a filter.

Particularly preferably, at least part of the mixture of monosilane and carrier gas is, after passing through the at least one decomposition reactor, branched off from the circuit and recirculated to section (1), in particular to the converting process for trichlorosilane in section (1).

As mentioned above, we also provide a plant for producing high-purity silicon. Such a plant comprises a production unit (1) for preparing trichlorosilane, a further unit (2) for preparing monosilane by disproportionation of the trichlorosilane prepared in unit (1) and a unit (3) for the thermal decomposition of the monosilane prepared into silicon and hydrogen.

Unit (1) has a plurality of components, namely at least one hydrochlorination reactor, at least one converting reactor, at least one collection vessel and at least one separation apparatus. As can be seen from what has been said above, the at least one hydrochlorination reactor has to be suitable for the reaction of silicon with hydrogen chloride to give a trichlorosilane-containing reaction mixture. The same product is also obtained in the at least one converting reactor which analogously has to be suitable for reaction of silicon tetrachloride with silicon and hydrogen. Suitable reactors are known.

In the at least one collection vessel, the trichlorosilane-containing reaction mixtures prepared in the hydrochlorination and in the converting can be mixed and stored. In the at least one separation apparatus which is preferably located downstream of the at least one collection vessel, the trichlorosilane-containing reaction mixtures can be separated at least partially into their components, which has likewise been described above. The condensate comprising various chlorosilanes thus passes through a state of chemical stabilization, i.e. formation of stable chemical states of the components at temperatures in the range from +20° C. to −50° C., preferably in the range from +10° C. to −20° C., over a period of from 2 to 8 days, preferably over a period of 5 days. After such a stabilization stage, the chlorosilanes from the processes of hydrochlorination and converting are combined in at least one vessel and subsequently passed on to separation of the components, where the mixture is separated into at least the main products trichlorosilane and tetrachlorosilane.

A unit (2) has at least one disproportionation reactor and at least one separation apparatus as components. The at least one separation apparatus serves, in particular, to separate chlorosilanes from the monosilane-containing reaction mixture, as mentioned above. The at least one disproportionation reactor has to be suitable for trichlorosilane from unit (1) to be able to be converted therein into a monosilane-containing reaction mixture, preferably under catalytic conditions. Such disproportionation reactors are also known, for example, from DE 10 2005 046 105.

Unit (3) comprises, inter alia, at least one decomposition reactor. As mentioned above, monosilane from unit (2) is, in admixture with a carrier gas, brought into contact with at least one support heated to a surface temperature of from 800° C. to 1450° C. in the decomposition reactor.

In addition, a plant is, in particular, characterized in that unit (2) is connected to unit (1) via at least one return line so that silicon tetrachloride obtained in unit (2) can be fed into the converting reactor in unit (1).

Preferably, the at least one separation apparatus in unit (1) is connected via at least one return line to the at least one converting reactor in unit (1). In this way, silicon tetrachloride which has been separated off in the at least one separation apparatus in unit (1) can be fed into the at least one converting reactor in unit (1).

The at least one separation apparatus in unit (2) can preferably be connected via at least one return line to the at least one disproportionation reactor in unit (2). This makes it possible for monochlorosilane, dichlorosilane and/or trichlorosilane separated off in the at least one separation apparatus in unit (2) to be fed into the at least one disproportionation rector for renewed reaction.

The at least one decomposition reactor in unit (3) is preferably connected via at least one return line to unit (1), in particular to the at least one converting reactor in unit (1). This is particularly advantageous when hydrogen is used as a carrier gas in the thermal decomposition of the monosilane. The hydrogen formed can thus be reused entirely within the process or within the plant.

The at least one separation apparatus in unit (1) and/or the at least one separation apparatus in unit (2) preferably comprises at least one distillation or rectification column.

The at least one disproportionation reactor is, in particular, at least one column, in particular a column filled to an extent of from 75 to 85% with a solid organic catalyst. This has already been mentioned in the context of the process. The relevant parts of the description are hereby incorporated by reference at this point.

Unit (3) is preferably configured so that the abovementioned mixture of monosilane and carrier gas can be circulated through the at least one decomposition reactor. Preference may be given to unit (3) having at least one means, preferably at least one blower, which enables forced convection to be achieved in the circuit. Unit (3) preferably has regulating and control means which allow the proportion of monosilane in the carrier gas and also the convection velocity to be set in a targeted manner. A suitable decomposition reactor is described, for example, in EP 0 181 803.

Further features may be derived from the following description of preferred examples. Individual features can in each case be realized either by themselves or in combination with one another in an example. The preferred examples described are merely for the purposes of illustration and to give a better understanding and are not to be construed as having any limiting effect.

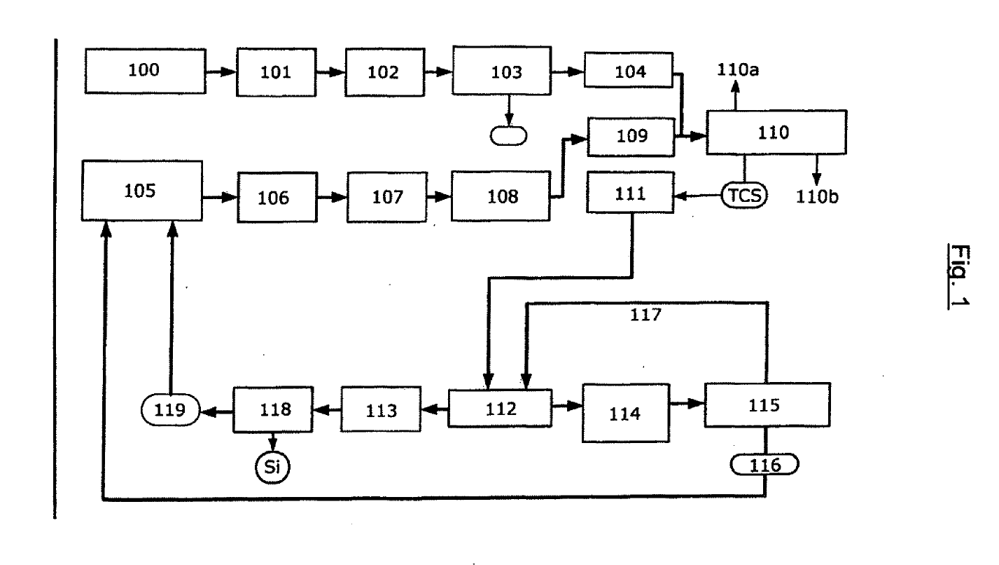

FIG. 1 shows an example of the process for producing high-purity silicon. The process is divided into three sections, namely the preparation of trichlorosilane, the preparation of monosilane by disproportionation of the trichlorosilane prepared and the thermal decomposition of the monosilane prepared.

In a hydrochlorination reactor 100, silicon is reacted with hydrogen chloride to give a trichlorosilane-containing reaction mixture. The reaction mixture obtained is then treated in a dry purification stage 101 and a wet purification stage 102 in order to largely remove, in particular, solid and water-soluble impurities. In the stage 103, the reaction mixture is subsequently condensed and then transferred to the collection vessel 104 for intermediate storage.

In parallel to the preparation of trichloro-silane by the hydrochlorination in the reactor 100, trichlorosilane is also produced in the converting reactor 105. Silicon tetrachloride is reacted with silicon and hydrogen to give a trichlorosilane-containing reaction mixture. This is treated in a dry purification stage 106 and a wet purification stage 107 in a manner analogous to the reaction mixture obtained by hydrochlorination. The purified reaction mixture is then condensed in stage 108 and subsequently subjected to intermediate storage in the collection vessel 109.

After intermediate storage in the collection vessels 104 and 109, the reaction mixtures are mixed and transferred to the separation apparatus 110 in which they are at least partially separated into their components. High- and low-boiling by-products are discharged via the outlets 110a and 110b. Via a return line (not shown), silicon tetrachloride which has been separated off is fed into the converting reactor 105. The purified trichlorosilane (TCS) is, on the other hand, passed to further processing in the collection vessel 111.

The purified trichlorosilane is subsequently reacted under catalytic conditions in the disproportionation reactor 112 to give a monosilane-containing reaction mixture. Low-boiling fractions having a high proportion of monosilane are continuously discharged from the disproportionation reactor during the disproportionation and purified in stage 113. Relatively high-boiling fractions having a high proportion of silicon tetrachloride and trichlorosilane are transferred from the disproportionation reactor via the collection vessel 114 to the separation apparatus 115. Silicon tetrachloride separated off from this is fed via the return line 116 into the converting reactor 105. Trichlorosilane which has been separated off is, on the other hand, reintroduced into the disproportionation reactor 112 via the return line 117.

The monosilane obtained in the disproportionation is transferred directly into the decomposition reactor 118 and in admixture with hydrogen as carrier gas brought into contact with supports heated to 800° C.-1450° C. (surface temperature) in this reactor. The silicon deposited in the reactor can be separated off relatively easily. At least part of the reaction mixture after passing through the decomposition reactor 118 is recirculated via the return line 119 to the converting reactor 105.

1-36. (canceled)

37. A process for producing high-purity silicon comprising:
(1) preparing trichlorosilane by reacting silicon with hydrogen chloride in at least one hydrochlorination process;
(2) preparing monosilane by disproportionation of the trichlorosilane to provide a monosilane-containing reaction mixture containing silicon tetrachloride as a by-product;
(3) in parallel to (1), reacting silicon tetrachloride obtained as the by-product in (2) with silicon and hydrogen in at least one converting process to produce a trichlorosilane-containing reaction mixture; and
(4) thermally decomposing the monosilane into silicon and hydrogen.

38. The process of claim 37, wherein (1) comprises at least one purification process in which the trichlorosilane-containing reaction mixture from the at least one hydrochlorination process and/or from the at least one converting process is freed of solid by-products.

39. The process of claim 38, wherein the purified reaction mixtures from the at least one hydrochlorination process and the at least one converting process are mixed and transferred to at least one common collection vessel.

40. The process of claim 39, wherein a mixing ratio of the reaction mixtures from the at least one hydrochlorination process and the at least one converting process is in the range from 1:10 to 10:1.

41. The process of claim 37, wherein (1) and (3) comprise at least one thermal separation process in which the trichlorosilane-containing reaction mixture from the hydrochlorination process and/or the converting process is at least partially separated into its components.

42. The process of claim 41, wherein silicon tetrachloride separated in the at least one thermal separation process is fed into the converting process in (3).

43. The process of claim 37, wherein the hydro-chlorination process is carried out at a temperature of 320° C. to 400° C. and at a pressure of 2 bar to 12 bar.

44. The process of claim 37, wherein the converting process is carried out at a temperature of 450° C. to 650° C. and at a pressure of 8 atm. to 15 atm.

45. The process of claim 37, wherein iron-containing silicon is reacted in the converting process.

46. The process of claim 37, wherein the disproportionation of the trichlorosilane in (2) is carried out under nonequilibrium conditions.

47. The process of claim 37, wherein the disproportionation is carried out over a solid organic catalyst.

48. The process of claim 47, wherein the disproportionation of the trichlorosilane prepared in (2) is carried out in at least one column, which is filled to 75-85% with the solid organic catalyst.

49. The process of claim 37, wherein the disproportionation is carried out at temperatures of 60° C. to 120° C. and at pressures of 2 atm. to 10 atm.

50. The process of claim 37, wherein (2) comprises at least one thermal separation process in which the monosilane-containing reaction mixture obtained in the disproportionation is at least partially separated into its components.

51. The process of claim 50, wherein monochlorosilane, dichlorosilane and trichlorosilane obtained in the separation of the reaction mixture is fed into a disproportionation reactor for renewed reaction.

52. The process of claim 37, wherein the thermal decomposition of the monosilane in (4) is carried out in a decomposition reactor in which the monosilane is brought into contact with at least one support heated to 800° C. 1450° C. (surface temperature).

53. The process of claim 52, wherein the monosilane is fed in admixture with a carrier gas into the at least one decomposition reactor.

54. The process of claim 53, wherein the mixture is circulated through the at least one decomposition reactor.

55. The process of claim 53, wherein at least part of the mixture is branched from the circuit after passing through the at least one decomposition reactor and recirculated to the converting process in (3).

56. A plant for producing high-purity silicon by the process of claim 37, comprising a production unit that prepares trichlorosilane, a further unit that prepares monosilane by disproportionation of the trichlorosilane prepared in the production unit and a decomposition unit that thermally decomposes the monosilane into silicon and hydrogen, wherein:
the production unit comprises at least one hydrochlorination reactor in which silicon is reacted with hydrogen chloride and produces a trichlorosilane-containing reaction mixture, at least one converting reactor in which silicon tetrachloride is reacted with silicon and hydrogen and produces a trichlorosilane-containing reaction mixture, at least one collection vessel in which the trichlorosilane-containing reaction mixtures prepared are mixed and/or stored and at least one separation apparatus downstream of the at least one collection vessel and in which and in which the trichlorosilane-containing reaction mixture is at least partially separated into its components;
the further unit comprises at least one disproportionation reactor in which trichlorosilane from the production unit is converted under catalytic conditions into silicon tetrachloride and a monosilane-containing reaction mixture and at least one separation apparatus in which chlorosilane is separated from the monosilane-containing reaction mixture; and
the decomposition unit comprises at least one decomposition reactor in which monosilane from the production unit is contacted with at least one support heated to 800° C.-1450° C. (surface temperature); and
the further unit is connected to the production unit via at least one return line via which silicon tetrachloride obtained in the further unit is fed into the at least one converting reactor in the production unit.

57. The plant of claim 56, wherein the at least one separation apparatus in the production unit is connected via at least one return line to the at least one converting reactor in the production unit so that silicon tetrachloride which has been separated in the at least one separation apparatus in the production unit is fed into the at least one converting reactor in the production unit.

58. The plant of claim 56, wherein the at least one separation apparatus in the further unit is connected via at least one return line to the at least one disproportionation reactor in the further unit so that chlorosilane which has been separated in the at least one separation apparatus in the further unit is fed into the at least one disproportionation reactor for renewed reaction.

59. The plant of claim 56, wherein the at least one decomposition reactor in the decomposition unit is connected via at least one return line to the production unit to the at least one converting reactor in the production unit.

60. The plant of claim 56, wherein the disproportionation reactor comprises at least one column which is filled to 75-85% with a solid organic catalyst.
